(19) United States
(12) Patent Application Publication
(10) Pub. No.: US 2021/0074298 A1
(43) Pub. Date: Mar. 11, 2021

(54) VIDEO CONFERENCE CAPTIONING

(71) Applicant: SoundHound, Inc., Santa Clara, CA (US)

(72) Inventor: Ethan Coeytaux, Boulder, CO (US)

(73) Assignee: SoundHound, Inc., Santa Clara, CA (US)

(21) Appl. No.: 16/567,760

(22) Filed: Sep. 11, 2019

(51) Int. Cl. G10L 15/26; G10L 15/02; G10L 15/14; G10L 15/19; G10L 19/005

(52) U.S. Cl. CPC G10L 15/265; G10L 15/02; G10L 19/005; G10L 15/19; G10L 15/14

(57) ABSTRACT

Aspects include adding text captioning to a video conference. Multiple conferencing endpoints participate in a video conference. An endpoint locally captures an audio stream and transcribes human speech included in the audio stream into a caption stream. The endpoint can multiplex the caption stream with the audio stream and/or with a captured video stream into a transport stream. The endpoint sends the transport stream to the one or more other conferencing endpoints. To increase reliability and effectiveness, the conferencing endpoint can send the caption stream redundantly. A receiving endpoint can receive and demultiplex the transport stream. The receiving endpoint can coordinate output of the caption stream, the audio stream, and the video stream at corresponding output interfaces.

### FIELD OF THE INVENTION

The present invention is applicable in the field of video conferencing.

### BACKGROUND

Video conferencing includes technologies for the transmission and reception of audio/video signals by users at different locations. In some environments, input capture devices (e.g., cameras, microphones, etc.) at each endpoint capture audio and video. Each end point combines the audio and video into an audio/video stream and sends the audio/video stream to a central server. The central server combines the individual audio/video streams into a combined audio/video stream. The central server then distributes the combined audio/video stream back to each endpoint.

Due to various network conditions (reduced bandwidth, higher latency, etc.) portions of an audio/video stream can be lost during transfer. When portions of an audio/video stream are lost, audio can become choppy possibly making any speech included in the audio difficult to understand. As such, a central server may also attempt transcribe audio into text in close to real time. The transcribed text can be distributed along with (and possibly integrated into) the combined audio/video stream. However, when part of an individual audio/video stream is lost during transmission from an endpoint to the central server, transcription accuracy may be reduced.

### SUMMARY OF THE INVENTION

According to some embodiments, multiple conferencing endpoints participate in a video conference. A conferencing endpoint locally captures an audio stream (e.g., at a microphone). The conferencing endpoint locally transcribes human speech included in the audio stream into a caption stream. The conferencing endpoint sends the caption stream to one or more other conferencing endpoints. In one aspect, the conferencing endpoint multiplexes the caption stream with the audio stream and/or with a captured video stream into a transport stream. The conferencing endpoint sends the transport stream to the one or more other conferencing endpoints. To increase reliability and effectiveness, the conferencing endpoint can send the caption stream redundantly such as by replication across network packets, using a forward error correction code, distribution of caption data across packets, or repeated sending in response to feedback from the one or more other conferencing endpoints.

According to other embodiments, a conferencing endpoint receives a transport stream from another conferencing endpoint. The transport stream includes a caption stream possibly multiplexed along with an audio stream and/or a video stream. The conferencing endpoint coordinates output of the transport stream. Coordinating output can include coordinating output of the audio stream at an audio output device with output of the caption stream (and possibly a video stream) at a display interface. A caption stream can be presented in a window along with a corresponding video stream or in a window separate from the corresponding video stream.

According to further embodiments, a conferencing endpoint receives a first transport stream and a second transport stream. The first transport stream includes a first caption stream, a first audio stream, and a first video stream. The second transport stream includes a second caption stream, a second audio stream, and a second video. The conferencing endpoint coordinates output of the first and second transport streams. Coordinating output can include presenting the first video stream in a first window and presenting the second video stream in a second window. Coordinating output can also include presenting the first caption stream in the first window near a person depicted in the first video stream and presenting the second caption stream in the second window near a person depicted in the second video stream. The first caption stream and second caption stream can be presented with different visual characteristics, such as, in different colors.

### BRIEF DESCRIPTION OF THE DRAWINGS

FIG. 1A depicts an example architecture for multiplexing a transport stream.

FIG. 1B depicts another example architecture for multiplexing a transport stream.

FIG. 2A depicts an example architecture of networked conferencing endpoints.

FIG. 2B depicts another example architecture of networked conferencing endpoints.

FIG. 2C depicts a further example architecture of networked conferencing endpoints.

FIG. 3 depicts an example architecture for transcribing audio into a caption stream.

FIG. 4 depicts an example architecture of a conferencing endpoint.

FIG. 5 depicts an example architecture for de-multiplexing a transport stream.

FIG. 6A depicts an example of output at a conferencing endpoint.

FIG. 6B depicts another example of output at a conferencing endpoint.

FIG. 7 depicts an example computer architecture for toggling presentation of a caption stream.

FIG. 8 depicts an example computer architecture for presenting caption streams with different visual characteristics.

FIG. 9A depicts an example computer architecture for resending a caption stream.

FIG. 9B depicts another example computer architecture for resending a caption stream.

FIG. 10 depicts an example computer architecture for consenting to voice transcription.

FIG. 11 depicts an example computer architecture for obscuring blacklisted speech.

FIG. 12 depicts an example computer architecture for muting caption streams and muting audio streams.

### DETAILED DESCRIPTION

In the following disclosure, reference is made to the accompanying drawings, which form a part hereof, and in which is shown by way of illustration specific implementations in which the disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but not every embodiment necessarily includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media. A system memory is a computer storage medium that stores computer-executable instructions.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. When information is transferred or provided over a network or another communications connection (either hardwired, wireless, or a combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. The computer executable instructions may be, for example, binaries, intermediate format instructions such as assembly language, or even source code. Although the subject matter is described in language specific to structural features and/or methodological acts, it is to be understood that the subject matter defined in the appended claims is not necessarily limited to the described features or acts described herein. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

These example devices are provided herein for purposes of illustration and are not intended to be limiting. Embodiments of the present disclosure may be implemented in further types of devices, as would be known to persons skilled in the relevant art(s).

At least some embodiments of the disclosure are directed to computer program products comprising such logic (e.g., in the form of software) stored on any computer useable medium. Such software, when executed in one or more data processing devices, causes a device to operate as described herein.

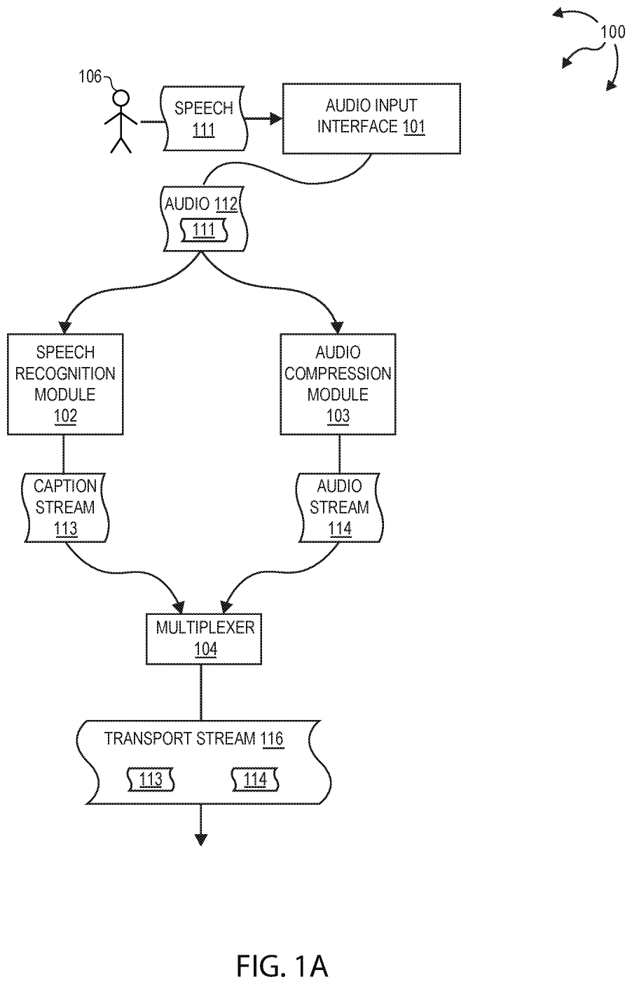

FIG. 1A depicts an example computer architecture 100 for multiplexing a transport stream. As depicted, computer architecture 100 includes audio input interface 101 (such as a microphone or receiver of electrically encoded audio comprising speech such as can be communicated by a universal serial bus (USB) or Bluetooth connection), speech recognition module 102, audio compression module 103, multiplexer 104, and (e.g., human) user 106. User 106 can emit speech 111 (e.g. spoken words) to the audio input interface 101. Audio input interface 101 can receive the speech 111. Audio input interface 101 can also receive other audio signals (e.g., background noise). Audio input interface 101 can send audio 112, including speech 111, to speech recognition module 102 and audio compression module 103.

Speech recognition module 102 can include automatic speech recognition (ASR) functionality. As such, speech recognition module 102 can convert speech into text. This can be performed with low enough latency that the words can be shown to a viewer within short enough time from the actual speech that the viewer can mentally associate the displayed words with the speech. For recorded or delayed communications, synchronization can be achieved by adding delay to the audio in order to allow enough time for accurate speech recognition. However, for real-time conferencing, relatively little delay is tolerable. Since many ASR systems use statistical language models that look at several or more recent words to predict a probability of a transcription, it can be difficult to predict a correct transcription with such little delay. As a result, system designers must make a trade-off between low latency and transcription accuracy.

Speech recognition module 102 can receive audio 112 from audio input interface 101. Speech recognition module 102 can convert speech 111 into text and include the text in caption stream 113. Speech recognition module 102 can send caption stream 113 to multiplexer 104.

Audio compression module 103 can include lossy and/or lossless audio compression functionality. As such, audio compression module 103 can compress received audio. For example, audio compression module 103 can compress audio 112 into audio stream 114. It is even possible for audio compression module 103 to apply no compression and simply encode raw audio into audio stream 114. Compression is useful for systems in which bandwidth is relatively expensive. Lesser or no compression is useful for systems in which latency is critical or computing resources are expensive. Audio compression module 103 can send audio stream 114 to multiplexer 104.

Multiplexer 104 can multiplex a caption stream and an audio stream into a transport stream such as a Motion Picture Experts Group (MPEG) transport stream format. For example, multiplexer 104 can multiplex caption stream 113 and audio stream 114 into transport stream 116.

FIG. 1B also depicts example computer architecture 100 for multiplexing a transport stream. In FIG. 1B, computer architecture 100 also includes video input interface 131 (e.g., including a camera) and video compression module 132. In FIG. 1B, video input interface 131 can capture video 158 of user 106 along with audio input interface 101 capturing speech 151 emitted by user 106 (as well as capturing other audio in the area). Various systems include different approaches to capturing video and audio inputs. A tablet or smartphone, for example, include one or more built-in cameras and microphones, controlled by an operating system such as Android or iOS. Multiple microphones can provide for a built-in ability to perform noise cancellation optimized for capturing speech. Some conference room systems also include multiple microphones but generally a single camera. In various systems, either or both of the camera and microphone(s) are peripheral components connected, such as through USB or Bluetooth, to a controlling endpoint device that includes a network connection. Some video cameras or other input devices include an ability to pan automatically or be moved manually and zoom in or out on subjects. This can be useful, for example, to focus clearly on a single user in some use cases or capture surrounding information such as a whiteboard, room, or scenery in other use cases.

Audio input interface 101 can send audio 152, including speech 151, to speech recognition module 102 and audio compression module 103. Speech recognition module 102 can convert speech 151 into text and include the text in caption stream 153. Speech recognition module 102 can send caption stream 153 to multiplexer 104. Audio compression module 103 can compress audio 152 into audio stream 154. Audio compression module 103 can send audio stream 154 to multiplexer 104. Multiplexer 104 can perform encoding of the stream with synchronization information such that receiving endpoints can time-synchronize video frames with audio samples and associated captions. Multiplexer 104 can also compute and encode error correcting codes and apply interleaving of data from the multiple elementary streams.

Video input interface 131 can send video 158 to video compression module 132. Video compression module 132 can include lossy and/or lossless video compression functionality. As such, video compression module 103 can compress received video. For example, video compression module 103 can compress video 158 into video stream 159. Video compression module 132 can send video stream 159 to multiplexer 104.

Various standard audio and video compression standards are applicable to various systems. For example, audio can be encoded in an uncompressed WAV format, a compressed MP3 streaming format, a royalty-free lossless format such as using the Free Lossless Audio Compression (FLAC) standard. Video can be encoded in an MPEG-4/H.264 Advanced Video Coding (AVC) format, an H.265 High Efficiency Video Coding (HEVC) format, or open royalty-free VP9 or AOMedia Video 1 (AV1) format.

Multiplexer 104 can multiplex a caption stream, an audio stream, and a video stream into a transport stream. For example, multiplexer 104 can multiplex caption stream 153, audio stream 154, and video stream 159 into transport stream 156.

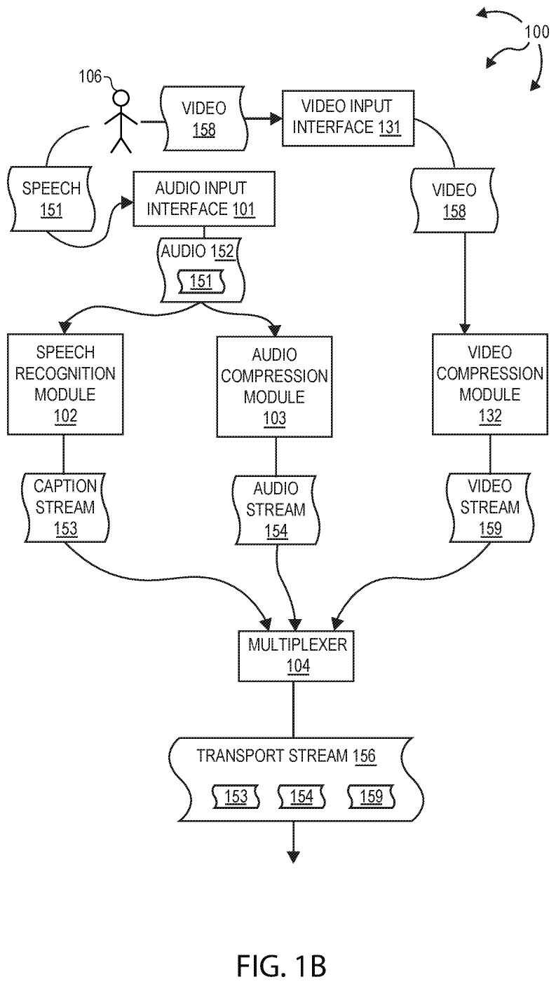

FIG. 2A depicts an example architecture 200 of networked conferencing endpoints. As depicted, architecture 200 includes endpoint 201 and endpoint 202. Endpoint 201 and endpoint 202 are connected to network 281. Either of endpoint 201 or endpoint 202 can include the modules and functionality depicted in FIGS. 1A and/or 1B. Thus, endpoint 201 can form a transport stream and send the transport stream over network 281 to endpoint 202. Similarly, endpoint 202 can form another transport stream and send the other transport stream over network 281 to endpoint 201. It is even possible in some example architectures or some modes of some architectures to have only one endpoint send a transport stream or to have the two endpoints send transport streams comprising different combinations of elementary streams.

FIG. 2B depicts another example architecture 210 of networked conferencing endpoints. As depicted, architecture 210 includes endpoint 211, endpoint 212, and endpoint 213. Endpoint 211, endpoint 212, and endpoint 213 are connected to network 281. Any of endpoint 211, endpoint 212, or endpoint 213 can include the modules and functionality depicted in FIGS. 1A and/or 1B. Thus, endpoint 211 can form a transport stream and send the transport stream over network 281 to endpoint 212 and endpoint 213. Similarly, endpoint 212 can form another transport stream and send the other transport stream over network 281 to endpoint 211 and endpoint 213. Likewise, endpoint 213 can form a further transport stream and send the further transport stream over network 281 to endpoint 211 and endpoint 212. Whereas example architecture 210 shows three endpoints, similar architectures can include more than three endpoints. Similarly, architectures can include more than one network. For example, some endpoints might be connected with high bandwidth and low latency on a local area network while some endpoints may be connected over the internet, including over low-bandwidth or high-latency links. In some architectures the links between endpoints encode streams use adaptive bitrate streaming techniques such as Hypertext Transfer Protocol (HTTP).

Some architectures allow for endpoints to be added and removed from architectures. In some cases, this is possible as part of a fixed setup. In some cases, the adding and removing of endpoints can be dynamically during an ongoing conference session. In some architectures, some or all endpoints communicate using a secured network. This is appropriate for military applications or ones with sensitive corporate or national security secrets. Some endpoints include data encryption, such as using the HTTP Live Streaming (HLS) Advanced Encryption Standard (AES) 128 protocol. In some architectures, the choice of encryption and the level of encryption are configurable. These are generally appropriate for consumer applications.

FIG. 2C depicts a further example architecture 220 of networked conferencing endpoints. As depicted, architecture 220 includes endpoint 221, endpoint 222, and central server 224. Endpoint 221, endpoint 222, and central server 224 are connected to network 281. Either of endpoint 221 or endpoint 222 can include the modules and functionality depicted in FIGS. 1A and/or 1B. Central 224 server can relay transport streams between endpoints. Central server 224 can also merge different transport streams together and send merged transport streams to endpoints. Merging streams at a server, might reduce the bandwidth required by each endpoint, but also might add latency for communication between endpoints, especially of they are accessible to each other directly over a low latency link. In some architectures, a central server provides more accurate ASR than is available locally within endpoint devices. However, performing ASR on each incoming endpoint stream before mixing audio can provide accurate ASR, even when users of different endpoints talk over each other.

Endpoint 221 can form a transport stream and send the transport stream over network 281 to central server 224. Central server 224 can relay the transport stream over network 281 to endpoint 222. Similarly, endpoint 222 can form another transport stream and send the transport stream over network 281 to central server 224. Central server 224 can relay the other transport stream over network 281 to endpoint 221.

In some architectures, a central server remultiplexes incoming elementary streams and sends them out to receiving endpoints. In some architectures the server decodes the elementary streams and performs audio mixing before sending out a single mixed audio elementary stream to endpoints. In some architectures, a central server combines video stream content incoming from different endpoints into a composite display with windows showing the video of one or more endpoints. Naturally, the composite video display should be different going out to each endpoint since the scene of interest at each endpoint is typically what is visible to cameras at other endpoints.

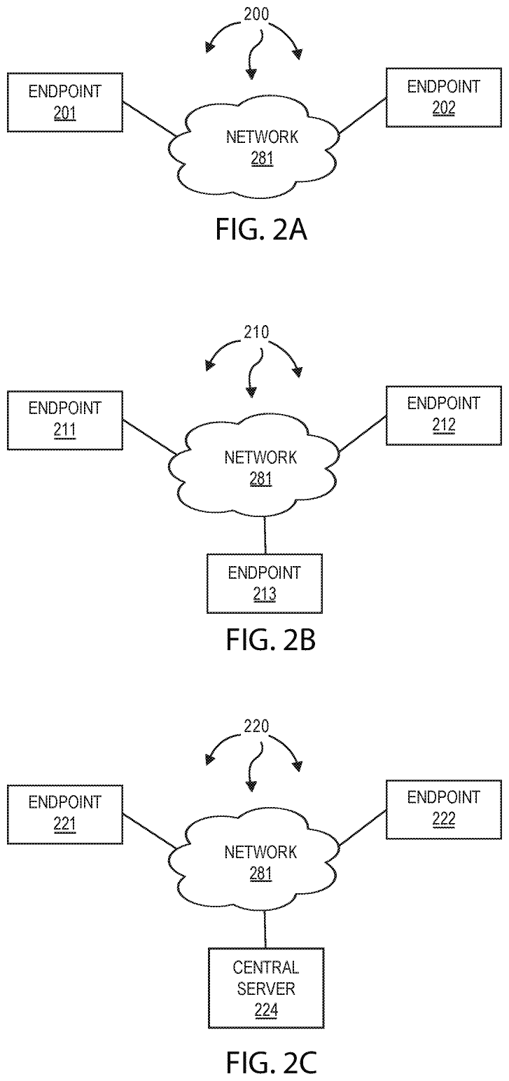

FIG. 3 depicts an example architecture 300 for transcribing audio into a caption stream. As depicted, architecture 300 includes speech recognition module 102, Natural Language Unit (NLU) 314, and grammars 316. Speech recognition module 102 can receive audio 312, including speech 311 (e.g., speech from user 106 or another user). Speech recognition module 102 can convert speech 111 into transcription hypothesis 317. Speech recognition module 102 can send transcription hypothesis 317 to NLU 314.

Various methods of ASR are appropriate in various endpoint systems depending on cost, accuracy, computing resource tradeoffs and other usage-dependent considerations such as device types and typical usage environments. For example, ASR for automobiles will generally be different than from mobile phones or corporate conferencing systems. Some appropriate ASR systems can use neural or Hidden Markov Model (HMM) acoustic models, phonetic dictionaries for tokenization, and n-gram or neural statistical language models (SLMs). Some systems include ASR capability in multiple languages with a configuration option to choose between them. Some systems perform automatic language detection and perform ASR in the language that they hypothesize, dynamically changing as the speaker or speech content changes. Some endpoints can perform firmware/software updates over the network to improve the algorithms and resulting accuracy of ASR. Some systems download dictionary updates to accommodate the changing lexicon of human languages or usage-specific lexicons.

NLU 314 can evaluate transcription hypotheses 317 according to grammars 316 to inform speech recognition. Grammars 316 can be natural language grammars and can include user-specific grammars and/or topic-specific grammars. NLU 314 can send caption stream 313 to a multiplexer (e.g., multiplexer 104). Some systems detect topics by techniques such as keyword detection or matching of a large amount of recognized words to words in grammars. Some endpoints update their grammars by downloading new grammar rules over the network. This is useful to adapt to changing terminology in specific fields or the introduction of new memes or popular culture content over time. In some systems with user-specific grammars, endpoints add user-specific information to local or network storage of user profile information. For example, the names of a user's contacts a user's calendar information, or content from user's text messages can help improve recognition accuracy.

Whereas some conventional ASR systems produce text transcriptions using acoustic models and SLMs, interpreting transcribed text according to semantic grammars, even if the interpretations are not used for any action, can improve recognition accuracy. Whereas a SLM would give a transcription “raining cats and dogs throughout the house” a high probability score due to the high frequency of each word in its context, that transcription would be unlikely to match any semantic grammar, whereas a transcription “running cats and dogs throughout the house” would score lower by an SLM, it would be a more likely parse according to a grammar and, therefore, probably the correct speech transcription.

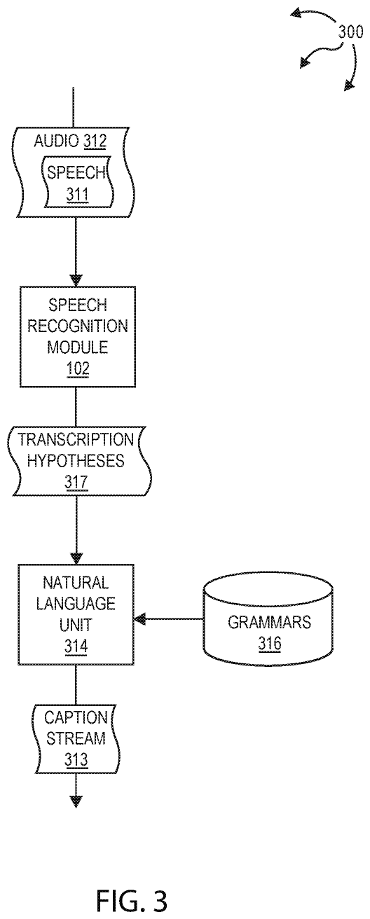

FIG. 4 depicts an example architecture of a conferencing endpoint 400. As depicted, conferencing endpoint 400 includes audio input interface 401, video input interface 432, network interface 433, audio output interface 434, and video output interface 436. Conferencing endpoint 400 can receive input audio through audio input interface 401. Conferencing endpoint 400 can receive input video through video input interface 432. Conferencing endpoint 400 can multiplex input audio and input video into an output transport stream (including one or more of: a caption stream, an audio stream, and a video stream). Conferencing endpoint 400 can send the output transport stream to other conferencing endpoints through network interface 433.

Conferencing endpoint 400 can also receive an input transport stream (including one or more of: a caption stream, an audio stream, and a video stream) through network interface 433. Conferencing endpoint 400 can demultiplex the input transport stream into output audio and output video (including text of transcribed speech). Conferencing endpoint 400 can present output audio at audio output interface 413 (e.g., including an audio speaker). Conferencing endpoint 400 can present output video and text of transcribed at video output interface 436 (e.g., including a display monitor).

In various systems, the input side of the conferencing endpoint performs little manipulation of the audio or video before compression and encoding into the transport stream, the output side typically requires more complex processing. This is particularly true for the video output. Even for endpoints that do not support or endpoint usage modes that do not include display of video from another endpoint, a visual display is necessary for the captions. Some such endpoints can have very simple displays, such as an LCD character display as would be found on a pager or walkie-talkie. The display merely renders text according to the caption stream either immediately as the stream is decoded or after passing through a synchronization process using synchronization codes in the transport stream.

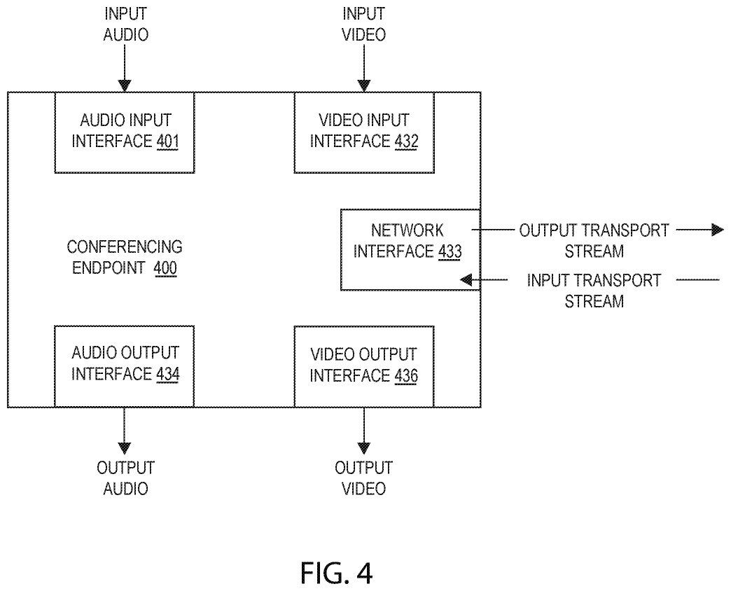

FIG. 5 depicts an example architecture 500 for de-multiplexing a transport stream. As depicted, architecture 500 includes demultiplexer 504, video output interface 434, and audio output interface 436. Demultiplexer 504 can receive transport stream 516, including caption stream 553, audio stream 554, and video stream 556. Demultiplexer 504 can demultiplex transport stream 516. Demultiplexer 504 can send caption stream 553 and video stream 556 to video output interface 434 and can send audio stream 554 to audio output interface 436. Video output interface 434 can present caption stream 553 and video stream 556. Audio output interface 436 can present audio stream 554. In some endpoints the demultiplexer and in some endpoints alternative logic (not shown) perform synchronization of the audio, video, and captions streams according to synchronization codes embedded in the transport stream 516. This ensures truest accuracy to the live audio and video input at the capturing endpoint. In some endpoints, synchronization codes are not used and the audio, video, and caption information is output as soon as it can be decoded. This can provide the lowest latency and also a simpler encoding protocol.

In endpoints with modes of operation the display a video stream(s) captured from one or more other endpoints, the video output interface must arrange the display of the captions from each of the one or more endpoints and the video content from each of the one or more endpoints providing video streams. Video stream content and output displays tend to be rectangular whereas captions tend to be strings of text.

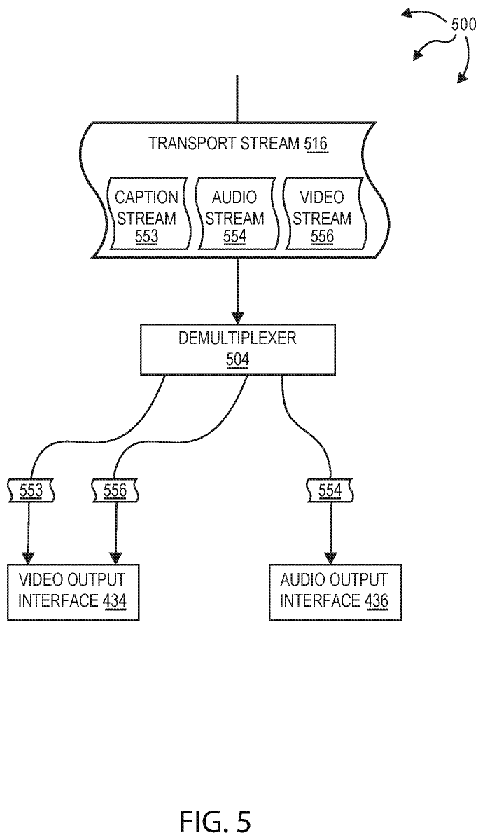

Consider a scenario of a 3-way video conference between Alice, Bob, and Charlie. FIG. 6A depicts an example output format 600 at Charlie's conferencing endpoint. As depicted in output 600, a large rectangle is devoted to Alice as a speaker of primary interest. A video stream from Bob's endpoint is shown in a smaller rectangular window in the upper right of the display. This layout can be useful for a video conference that includes many participants whose video feeds can be stacked in a column on the right. For a very large number of participants, the column might be enabled to scroll. In the display 600, transcription of speech from Alice and Bob is presented outside of the windows associated with Alice and Bob. This is useful also for large conferences that might include many speakers, not all of whose video streams can be shown in a large format. This provides for a viewer to see all speech in the conference even when the video display cannot easily show the speech closely to the speaker. Some systems automatically shift the large displayed video stream based on which capturing endpoint detects speech so that the speaker is always in sight. However, for speech in a conversation with frequent turn taking this can cause an annoying amount of switching. Having a dedicated caption section of the display is helpful for showing the dialog even when there is a lot of display switching or in a system or mode that does not frequently change the video stream in primary focus. This can have the disadvantage of not clearly associating the caption text with which the video window corresponding to the endpoint from which the caption was captured. This can be addressed using color or other visual clues to associate caption text with speaker window. For example, each window can be shown with a uniquely colored frame and the text be shown with the same color. For another example, each window can be displayed with a name and the beginning of each line of caption text can be shown with the name corresponding to the window before a colon (“:”) character.

FIG. 6B depicts another example output format 650 at a conferencing endpoint. As depicted in output 650, transcription of Alice's speech is presented inside a window associated with Alice. Similarly, transcription of Bob's speech is presented inside a window associated with Bob. This is simpler with respect to the fact that it is easier to visually associate the caption text with the video stream coming from the same endpoint. This is useful for visual formats appropriate for smaller conferences with only two endpoints or a small number such as a maximum of 4 endpoints. This is more common for consumer conferencing systems. Output format 650 shows caption text overlaid on the frames of video streams from the same endpoints as the captions. Some systems, either at the endpoints or at a central server, perform region of interest detection and align the overlaid captions at a display location with minimal overlap of regions of interest. A particularly important type of region of interest is one showing a person and especially a face. Algorithms, such as neural networks trained for objection recognition and alignment, can build live maps of video displays indicating areas of greatest and least interest.

Some systems left justify or right justify text based on where it is best displayed. Some dynamically display caption text in different screen locations as the view changes, such as a person moving around within the frame. Some systems adapt the color, outline, or shadowing of the text based on the background in order to improve contrast and therefore readability. Some systems display the caption text in long rectangular sections such as ones that are completely black with white text completely obscuring the regions of video over which the text is displayed. Some systems detect lip movement in order to detect which person is speaking or where the mouth of a speaker is and then display caption text in a cartoon-like callout box with a point towards the speaker's mouth. This can be both fun to watch and helpful to show who is speaking within a frame showing multiple people.

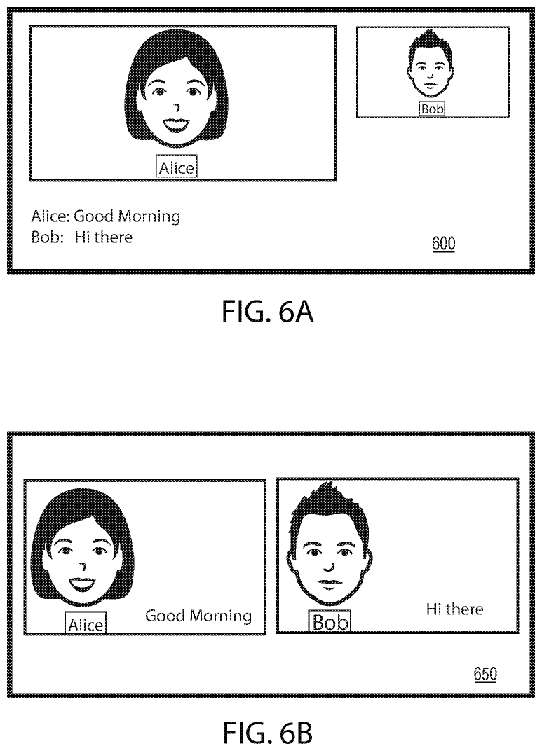

FIG. 7 depicts an example computer architecture 700 for toggling presentation of a caption stream. As depicted, computer architecture 700 includes toggle application module 702, toggle setting module 703, audio output interface 436, and video output interface 434. A demultiplexer (e.g., demultiplexer 504) can demultiplex a transport stream into audio stream 754, video stream 756, and caption stream 753. Audio output interface 436 can present audio stream 754. Video output interface 434 can present video stream 756.

A network monitor (not shown) can derive network characteristics 712 of a network, such as, network 281. Network characteristics 712 can relate to bandwidth, latency, etc. of the network. Toggle setting module 703 can receive audio stream 754 and network characteristics 712. Toggle setting module 703 can derive characteristics of audio stream 754, such as, for example, compression settings, protocols, spoken language, user accent, does audio stream 754 contain speech that temporally overlaps with speech in other audio streams, etc.

Toggle setting module 703 can automatically toggle captions “on” or “off” based on characteristics of audio stream 754 and network characteristics 712. Toggle setting module 703 can indicate in toggle setting 711 if captions are toggled “on” or “off”. Toggle setting module 703 can dynamically change toggle setting 711 (e.g., between “on” and “off”) as characteristics of audio stream 754 and/or network characteristics 712 change. This can be useful to provide the best service adaptively as network conditions change, such as in a moving vehicle that can intermittently lose access to high bandwidth data links.

In another aspect, a user (e.g., user 106) submits manual input 713 to toggle setting module 703. Manual input 713 indicates if captions are to be toggled “on” or “off”. Toggle setting module 703 can indicate in toggle setting 711 if captions are toggled “on” or “off” in accordance with manual input 713. Manual input 713 may be used to change or override an automatic toggle setting that was derived based on characteristics of audio stream 754 and/or network characteristics 712.

Toggle application module 702 can receive caption stream 753. Toggle application module 702 can refer to toggle setting 711. Based on toggle setting 711, toggle application module 702 may or may not pass caption stream 753 on to video output interface 434. When toggle setting 711 indicates that captions are toggled “on”, toggle application module 702 passes caption stream 753 to video output interface 434. Video output interface 434 can present caption stream 753 as described. On the other hand (and as depicted in FIG. 7), when toggle setting 711 indicates that captions are toggled “off”, toggle application module does not pass caption stream 753 to video output interface. It can be very desirable for users to be able to disable the display of captions. This is especially true in display formats such as display format 600 since captions consume screen area and therefore require video stream displays to be smaller and therefore lower resolution. It is also possible in some systems or endpoints to be able to change the display format, such as between the format 600 and format 650 and other variations.

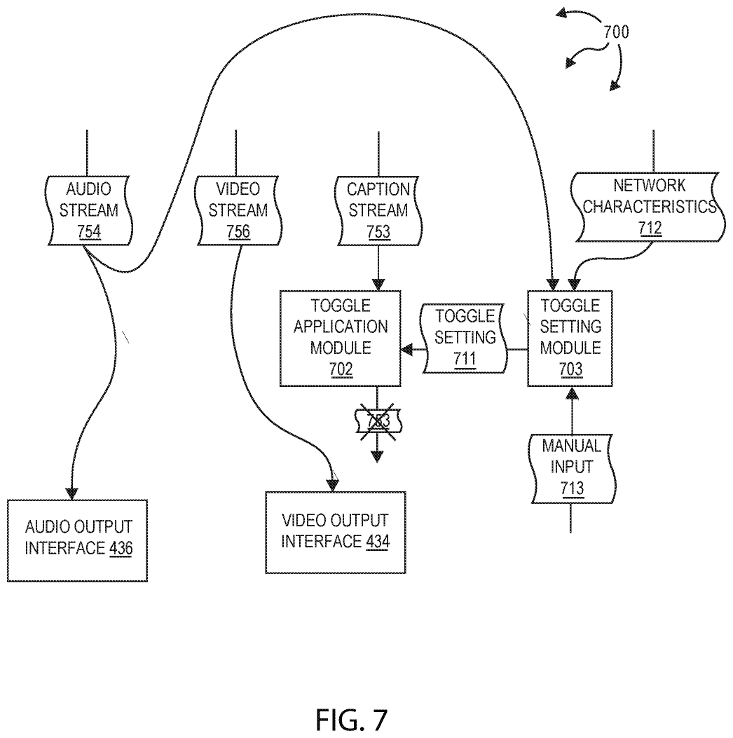

FIG. 8 depicts an example computer architecture 800 for presenting caption streams with different visual characteristics. As depicted, computer architecture 800 includes endpoints 801, 802, and 803. Endpoints 801, 802, and 803 can be connected to a network, such as, network 281. Endpoint 801 can send transport stream 851, including audio stream 854 and caption stream 853, to endpoint 803. Similarly, endpoint 802 can send transport stream 852, including audio stream 856 and caption stream 857, to endpoint 803.

Endpoint 803 further includes network interface 833, audio output interface 834, video output interface 836, and demultiplexer 837. Endpoint 803 can receive transport streams 851 and 852 at network interface 833. Demultiplexer 837 can demultiplex transport streams 851 and 852. Demultiplexer 837 can send audio streams 854 and 856 to audio output interface 834. Audio output interface 834 can mix audio streams 854 and 856 and present them to an endpoint viewer.

Demultiplexer 837 can send caption streams 853 and 857 to video output interface 836. Demultiplexer 837 can indicate that caption stream 853 is to be presented with visual characteristics 861 and that caption stream 857 is to be presented with visual characteristics 862. Visual characteristics 861 can indicate where caption stream 853 is to be presented (e.g., in a side window, in a window along with a person, etc.) and how caption stream 853 is to be presented (e.g., text color, other text characteristics, etc.). Visual characteristics 862 can indicate where caption stream 857 is to be presented (e.g., in a side window, in a window along with a person, etc.) and how caption stream 857 is to be presented (e.g., text color, other text characteristics, etc.).

Visual characteristics 861 and visual characteristics 862 can indicate different presentation qualities. For example, visual characteristics 861 may indicate that caption stream 853 is to be presented in one color and visual characteristics 862 may indicate that caption stream 857 is to be presented in another different color.

Video output interface 836 can perform video elementary stream compositing, character generation according to caption text, production of the text overlay, and then present caption stream 853 and caption stream 857 in accordance with characteristics 861 and 862 respectively.

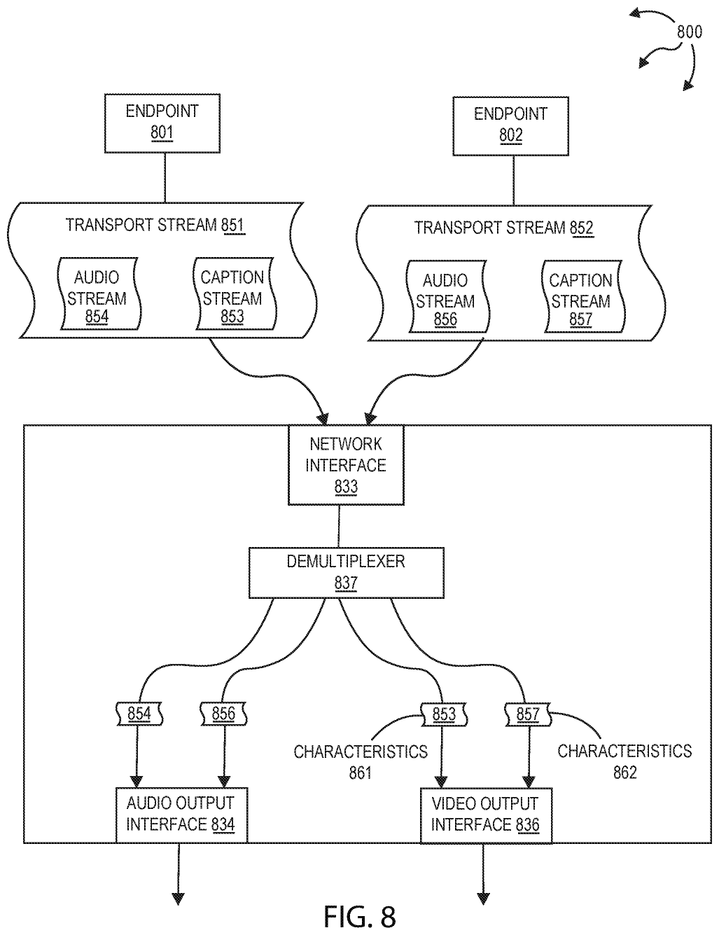

FIG. 9A depicts an example computer architecture 900 for resending a caption stream. As depicted, computer architecture 900 includes endpoint 901 and endpoint 902. Endpoint 901 can use network interface 933 to send caption stream 913 to endpoint 902. Due to network conditions, parts of caption stream 913 may be corrupted and/or lost during transmission. As such, network interface 936 may receive an incomplete and/or corrupt caption stream 913. Using error detection mechanisms, endpoint 902 can detect that caption stream 913 is incomplete and/or corrupt.

Endpoint 902 can use network interface 936 to send feedback 914 (e.g., a NACK) back to endpoint 901. Endpoint 901 can receive feedback 914 at network interface 933. In response to feedback 914, endpoint 901 can use network interface 933 to re-send caption stream 913 to endpoint 902. Accordingly, endpoint 901 includes some memory allocated to storing a buffer of caption information. Endpoint 901 keeps the caption information in the buffer either until it receives an ACK signal according to an appropriate protocol or until a specific amount of time after which either (a) it can be assume that the latency for a network round trip and error detection can be assumed to have passed or (b) the caption information is so far out of sync with the audio and/or video transmission that it would be confusing to present them together.

FIG. 9B depicts an example computer architecture 950 for resending a caption stream. As depicted, computer architecture 900 includes endpoint 901 and endpoint 902. Endpoint 901 can use network interface 933 to send caption stream 913 to endpoint 902. Timer 937 can indicate a time when caption stream 953 is to again be sent to endpoint 902. In response to timer 937 indicating the time, endpoint 901 can use network interface 933 to resend caption stream 953 to endpoint 902. Network interface 936 may receive the originally sent caption stream 953 and/or the resent caption stream 953. This requires only as much buffering as needed for the amount of time between the first and last replicated sending of the caption information, which is almost certainly less than the amount of buffering needed for computer architecture 900. However, the architecture 950 consumes more bandwidth over reliable channels. This can be acceptable for systems in which bandwidth is inexpensive, which is common since caption text requires orders of magnitude less information than needed for intelligible audio, which is much less than the information needed for meaningful video.

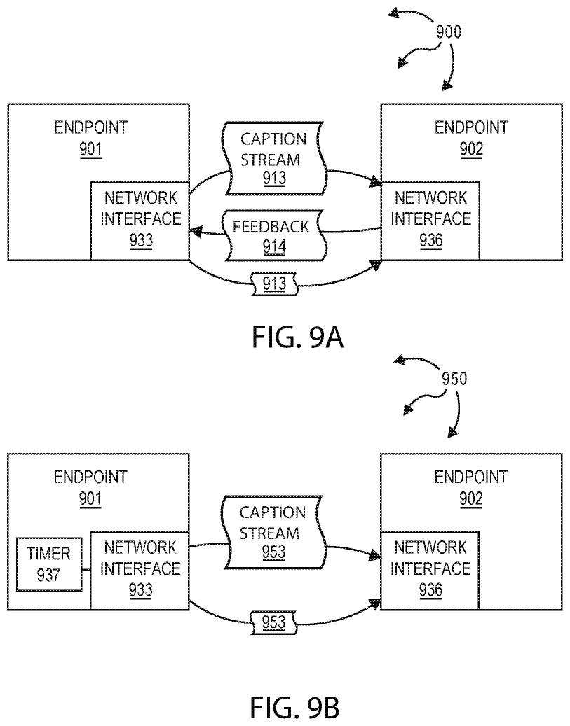

FIG. 10 depicts an example computer architecture 1000 for consenting to voice transcription. Computer system 1001 can send registration 1003 to endpoint 1002. Computer system 1001 can be a central server or another endpoint. Registration 1003 can include information for registering to participate in a video conference with one or more other endpoints.

Registration 1003 can request consent for one or more of: speech transcription, caption stream presentation, and caption stream archival as a condition(s) for participating in a video conference. Endpoint 1002 can return consent 1004 to computer system 1001. Consent 1004 can indicate acceptance of the one or more of: speech transcription, caption stream presentation, and caption stream archival. Upon receiving consent 1004, computer system 1001 can include endpoint 1002 in a video conference. The process of soliciting and receiving consent is necessary for compliance with laws in some jurisdictions. Some implementations provide for a conference system setup or app configuration to allow a general ongoing consent, such as an app permission requested by an Android or iOS app. Some implementations require users to provide consent each time that they join a conference, which improves their awareness of their degree of conversation privacy.

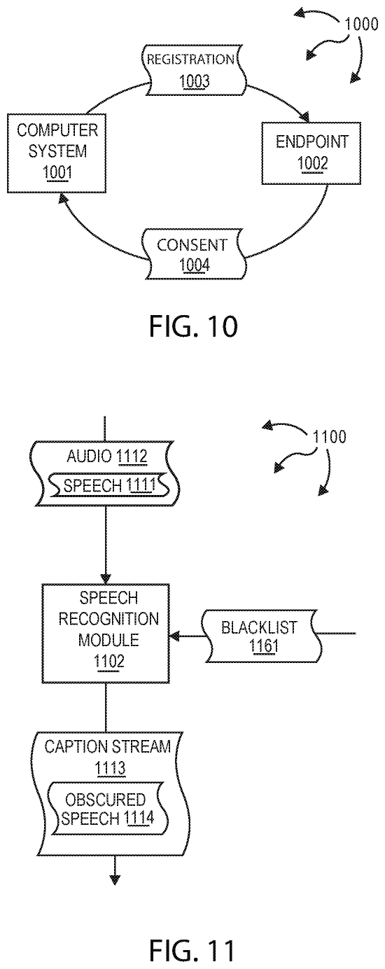

FIG. 11 depicts an example computer architecture 1100 for obscuring blacklisted speech. As depicted, computer architecture 1100 includes speech recognition module 1102 (e.g., at a conferencing endpoint). Speech recognition module 1102 can receive audio 1112, including speech 1111 (e.g., from an audio input interface). In general, speech recognition module 1102 can convert speech 1111 into caption stream 1113.

During speech to text conversion, speech recognition module 1102 can refer to blacklist 1161. Blacklist 1161 can indicate words, phrases, etc., that are to be obscured or removed from caption streams. Blacklist 1161 can include profanity, hate speech, other toxic speech, etc. Speech recognition module 1102 can obscure parts of caption stream 1113 in accordance with words, phrases, etc., included in blacklist 1161. For example, speech recognition module 1102 can output caption stream 1113 including obscured speech 1114. Caption stream 1113 can be sent to another conferencing endpoint.

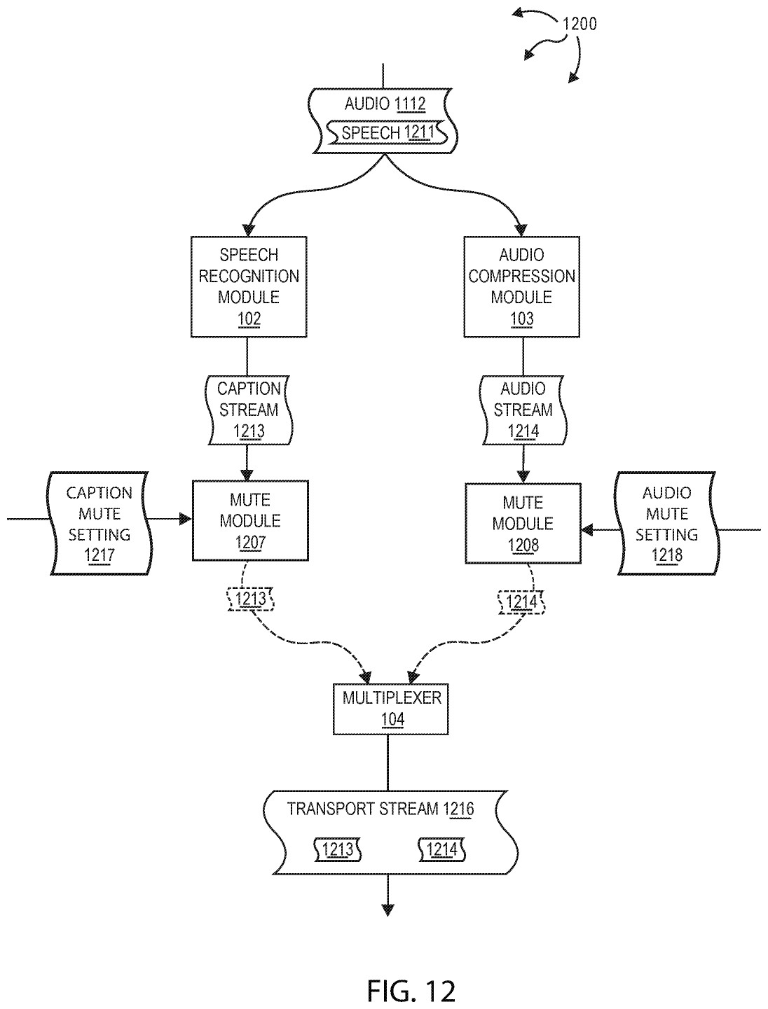

FIG. 12 depicts an example computer architecture 1200 for muting caption streams and muting audio streams. As depicted, computer architecture 1200 includes speech recognition module 102, audio compression module 103, mute module 1207, mute module 1208, and multiplexer 1004 (e.g., at a conferencing endpoint). Speech recognition module 102 and audio compression module 103 can receive audio 1212, including speech 1211 (e.g., from an audio input interface). In general, speech recognition module 102 can convert speech 1211 into caption stream 1213 and audio compression module 103 can convert audio 1212 into audio stream 1214.

Speech recognition module 102 can send caption stream 1213 to mute module 1207. Mute module 1207 can refer to caption mute setting 1217. Caption mute setting 1217 can indicate if captions are muted or are not muted. If captions are not muted, mute module 1207 sends caption stream 1213 to multiplexer 104. On the other hand, if captions are muted, mute module 1207 does not send caption stream 1213 to multiplexer 104. Caption mute setting 1217 can be set and/or changed via user input commands at a sending endpoint. Caption mute setting 1217 can be set and/or changed via user input commands at a sending endpoint.

Audio compression module 103 can send audio stream 1214 to mute module 1208. Mute module 1208 can refer to audio mute setting 1218. Audio mute setting 1218 can indicate if audio is muted or is not muted. If audio is not muted, mute module 1208 sends audio stream 1214 to multiplexer 104. On the other hand, if audio is muted, mute module 1208 does not send audio stream 1214 to multiplexer 104. Audio mute setting 1218 can be set and/or changed via user input commands at a sending endpoint.

Caption mute setting 1217 and audio mute setting 1218 can be set and/or changed independently and separately. As such, both captions and audio can be muted, captions can be muted while audio is not muted, audio can be muted while captions are not muted, or both captions and audio are not muted. Some systems or endpoints perform both caption and audio mute in tandem so that users intending to exchange words locally without sharing them across the conference are able to do so without accidentally forgetting to mute one or the other stream.

Multiplexer 104 can multiplex non muted caption stream 1213 and/or non-muted audio stream 1214 into transport stream 1216. Thus, transport stream 1216 may include neither caption stream 1213 nor audio stream 1214, may include caption stream 1213 but not audio stream 1214, may include audio stream 1214 but not caption stream 1213, or may include both of caption stream 1213 and audio stream 1214. Transport stream 1216 can be sent to another conferencing endpoint. Some systems or endpoints further allow muting (aka blanking) of a video stream independently from that of an audio and/or caption stream.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments but should be defined only in accordance with the following claims and their equivalents. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. A conferencing endpoint comprising:
an audio input interface;
a network interface;
a processor;
system memory coupled to the processor and storing instructions configured to cause the processor to:
coordinate connection of the conferencing endpoint via the network interface to a network conference including one or more other conferencing endpoints;
capture an audio stream from the audio input interface;
recognize speech to create a caption stream;
multiplex the audio stream and the caption stream into a transport stream; and
send the transport stream to the one or more other conferencing endpoints via the network interface.

2. The conferencing endpoint of claim 1, further comprising a video input interface;
the system memory further storing instructions configured to cause the processor to capture a video stream from the video input interface; and
wherein instructions configured to multiplex the audio stream and the caption stream into a transport stream comprise instructions configured to multiplex the audio stream, the caption stream, and the video stream into the transport stream.

3. The conferencing endpoint of claim 1, wherein instructions configured to coordinate connection to a network conference comprise instructions configured to coordinate connection to a plurality of conferencing endpoints including a first conferencing endpoint and a second endpoint; and
wherein instructions configured to send the transport stream to the one or more other conferencing endpoints comprises instructions configured to:
send the transport stream directly to the first conferencing endpoint; and
send the transport stream directly to the second conferencing endpoint.

4. The conferencing endpoint of claim 1, wherein instructions configured to recognize speech comprise instructions configured to evaluate transcription hypotheses according to natural language grammars to inform speech recognition.

5. The conferencing endpoint of claim 4, wherein the natural language grammars include a user-specific grammar.

6. The conferencing endpoint of claim 4, wherein the natural language grammars include a topic-specific grammar.

7. The conferencing endpoint of claim 1, further comprising a display interface and an audio output interface;
the system memory further storing instructions configured to:
receive another transport stream, including another audio stream and another caption stream corresponding to the other audio stream, directly from another conferencing endpoint; and
coordinate outputs at the conferencing endpoint, including coordinating output of the other audio stream at the audio output device with output of the other caption stream at the display interface.

8. The conferencing endpoint of claim 7, wherein instructions configured to receive another transport stream comprise instructions configured to receive the other transport stream including another video stream; and
wherein instructions configured to coordinate outputs at the conferencing endpoint comprise instructions configured to:
present the video stream in a window at the display interface; and
present the other caption stream in a different window supplementing presentation of the video in the window.

9. The conferencing endpoint of claim 7, wherein instructions configured to receive another transport stream comprise instructions configured to receive the other transport stream including another video stream; and
wherein instructions configured to coordinate outputs at the conferencing endpoint comprise instructions configured to:
present the other video stream in a window at the display interface; and
present the other caption stream in the window.

10. The conferencing endpoint of claim 7, wherein instructions configured to coordinate outputs at the conferencing endpoint comprise instructions configured to:
determine that caption presentation is toggled off; and
not present the other caption stream at the display device in response to the determination.

11. The conferencing endpoint of claim 10, the system memory further storing instructions configured to toggle captioning off based on one or more of: network characteristics or characteristics of speech included in the other audio stream.

12. The conferencing endpoint of claim 7, the system memory further storing instructions configured to receive a further transport stream, including a further audio stream and a further caption stream corresponding to the further audio stream, directly from a further conferencing endpoint, the further conferencing endpoint included in the one or more other conferencing endpoints; and
wherein instructions configured to coordinate outputs at the conferencing endpoint comprise instructions configured to:
present the other caption stream at the display interface with first visual characteristics; and
present the further caption stream at the display interface with second visual characteristics, the second visual characteristics differing from the first visual characteristics.

13. The conferencing endpoint of claim 12, the system memory further storing instructions configured to detect that the other caption stream includes speech that temporally overlaps with speech included in the further caption stream;
wherein instructions configured to receive another transport stream comprise instructions configured to receive the other transport stream including another video stream;
wherein instructions configured to receive a further transport stream comprise instructions configured to receive the further transport stream including a further video stream;
wherein instructions configured to output the other caption stream at the display interface with first visual characteristics comprise instructions configured to present the other caption stream along with a person depicted in the other video stream in a window; and
wherein instructions configured to output the further caption stream at the display interface with second visual characteristics comprise instructions configured to simultaneously present the further caption stream along with a person depicted in the further video stream in another window.

14. The conferencing endpoint of claim 12, wherein instructions configured to output the other caption stream at the display interface with first visual characteristics comprise instructions configured to present the other caption stream in a first color; and
wherein instructions configured to output the further caption stream at the display interface with second visual characteristics comprise instructions configured to present the further caption stream in a second color, the second color differing from the first color.

15. The conferencing endpoint of claim 1, the system memory further storing instructions configured to compress the audio stream; and
wherein instructions configured to multiplex the audio stream and the caption stream into a transport stream comprises instructions configured to multiplex the compressed audio stream and the caption stream.

16. The conferencing endpoint of claim 1, the system memory further storing instructions configured to send the caption stream to the one or more other conferencing endpoints redundantly.

17. The conferencing endpoint of claim 16, wherein the redundancy is by use of a forward error correction code.

18. The conferencing endpoint of claim 1, the system memory further storing instructions configured to receive consent to transcribe recognized speech via meeting registration at the conferencing endpoint.

19. The conferencing endpoint of claim 1, wherein instructions configured to recognize speech comprise instructions configured to recognize a speech portion included in a blacklist; and
the system memory further storing instructions configured to adjust the caption stream to obscure presentation of the speech portion at the one or more other conferencing endpoints.

20. The conferencing endpoint of claim 1, the system memory further storing instructions configured to mute the audio stream and suspend multiplexing the audio stream into the transport stream.

21. The conferencing endpoint of claim 1, the system memory further storing instructions configured to mute the caption stream and suspend multiplexing the caption stream into the transport stream.

22. A method of generating a caption stream, the method comprising:
performing automatic speech recognition on a first audio stream to create a first caption stream;
performing automatic speech recognition on a second audio stream to create a second caption stream;
combining the first caption stream and the second caption stream into a combined caption stream; and
transmitting the combined caption stream over a network.

23. A method comprising:
coordinating connection of the conferencing endpoint via the network interface to a network conference including one or more other conferencing endpoints;
capturing an audio stream from the audio input interface;
recognizing speech to create a caption stream;
multiplexing the audio stream and the caption stream into a transport stream; and
sending the transport stream to the one or more other conferencing endpoints via the network interface.
